(19) United States
(12) Patent Application Publication
(10) Pub. No.: US 2007/0264611 A1
(43) Pub. Date: Nov. 15, 2007

(54) Self-Adaptable Intraoral Device for Correcting the Asymmetry of Temporomandibular Joints

(76) Inventors: Bogumila Sobczak, Velizy Villacoublay (FR); Andre Gastaldi, Brunoy (FR)

Correspondence Address: YOUNG & THOMPSON, 745 SOUTH 23RD STREET, 2ND FLOOR, ARLINGTON, VA, 22202, US

(21) Appl. No.: 10/558,643

(22) PCT Filed: May 27, 2004
(86) PCT No.: PCT/FR04/01309

§ 371 Date: Nov. 30, 2005

(30) Foreign Application Priority Data
Jun. 2, 2003 (FR) 03/06645

(51) Int. Cl. A61C 7/36

(52) U.S. Cl. 433/148

(57) ABSTRACT

A self-adaptable intraoral device for correcting oneself the asymmetry of temporomandibular joints, includes two soft pads (1) which are to be clamped between the upper and lower molars and are interconnected by a connecting element in order to prevent them from being swallowed. The inventive device is characterised in that the connecting element consists of two rigid rods (3, 7, 14), the ends of the rods being respectively fixed to a pad (1), and the other ends, opposing the pads (1), being interconnected by a part (4, 8, 15) which acts as a hinge and enables the distance between the two pads (1) to be adjusted.

The present invention relates to an auto-adaptable intraoral device for correcting the asymmetry of temporomandibular joints.

The temporomandibular joints are those positioned highest in humans. According to ancient Chinese medicine the state of these joints has an influence on the state of the other joints. Imperfections in occlusion affect the functional state of the temporomandibular joints.

The slightest difference in occlusion on one side can result in poor symmetry of the temporomandibular joints.

Certain apparatuses are known and used in the orthopedic correction of the jaw, in respect of anomalies caused by thumb-sucking, breathing with the mouth open, habitual chewing of the tongue or lips, difficulties in positioning the jaw on the sagittal, transversal and horizontal planes and the dysfunctioning of the joints due to a trauma such as a fracture, for example.

The publication “La production des appareils mobiles” [The production of mobile apparatuses], éditions Kiwintesencja 1992, pages 143/148, contains a description of different apparatuses used for the correction of problems of malocclusion. This type of apparatus is used only at the entrance to the mouth. It is not introduced between the upper and lower teeth and is not held by clamping the teeth. These apparatuses require an impression of the jaw, which incurs expenses, and customization.

The patent application in the name of Madame Bogumila SOBCZAK filed on 25 Sep. 1996 in Poland and published under the no. P-315849 describes two elastic elongated cylindrical pads, intended to be clamped between the teeth and two junctions which join a gripping ring.

The daily use of this device is advised as an exercise which consists of putting the pads in the mouth so that they are situated between the upper and lower molars held clamped for approximately fifteen seconds. This simple exercise leads to the correction of the positioning of the temporomandibular joints and the re-establishment of symmetry on the sagittal, transversal and horizontal planes after approximately ten days according to Doctor Bogumila SOBCZAK's thesis and its publication in FIZJOTERAPIA NR3, 1997, pages 25, 26 and 27 in WROCLAW (Poland).

The drawback of this device resides in the fact that the pads and connection are made of the same flexible material, which makes their positioning and consequently the use of the device very difficult.

The device according to the present invention makes it possible to remedy this drawback.

According to the invention, the auto-adaptable intraoral device for the self-correction of the asymmetry of the temporomandibular joints comprises two pads of flexible material each intended to be clamped between the upper and lower molars, these two pads being connected to each other by a tie in order to prevent them from being swallowed, and is characterized in that said tie is constituted by two rods of rigid material the ends of which are each fixed to a pad, the ends of the rods opposite the pads being connected to each other by a part forming a hinge making it possible to adjust the distance between the two pads.

This arrangement facilitates the positioning of the two pads of the device between the upper and lower molars and makes it possible to adjust the distance between the two pads so that it corresponds to the distance between the molars which varies depending on the individual.

Preferably, the two pads are of flexible plastic and are moulded onto the ends of said rods.

According to another feature of the invention, the two pads are substantially parallel to each other, and when they are not acted on manually, the distance between them corresponds to that between the molars of a jaw of average size.

According to another feature, the two rods comprise, opposite the pads, two bends directed one towards the other which are extended by two rod sections connected to each other by a flexible part forming a hinge.

Preferably, said flexible part is constituted by a narrowing of the connection between the two rods.

According to an advantageous characteristic, said rod sections extend beyond the flexible part forming a hinge, to constitute on both sides of the latter support surfaces for the thumb and index finger allowing adjustment of the distance between the two pads perpendicular to the molars before they are clamped by the latter.

According to another advantageous version each pad comprises two opposite support faces intended to come into contact with the molars, comprising ribs, humps or other unevennesses.

This arrangement allows a better seating of the molars on the pads.

According to another feature, the pads comprise on their internal side face a fin suitable for guiding these pads laterally with respect to the molars.

This arrangement facilitates the positioning of the pads between the molars.

Other characteristics and advantages of the invention will also become apparent in the following description.

In the attached drawings, given as non-limitative examples,

FIG. 1 is a top view of a first version of the device according to the invention,

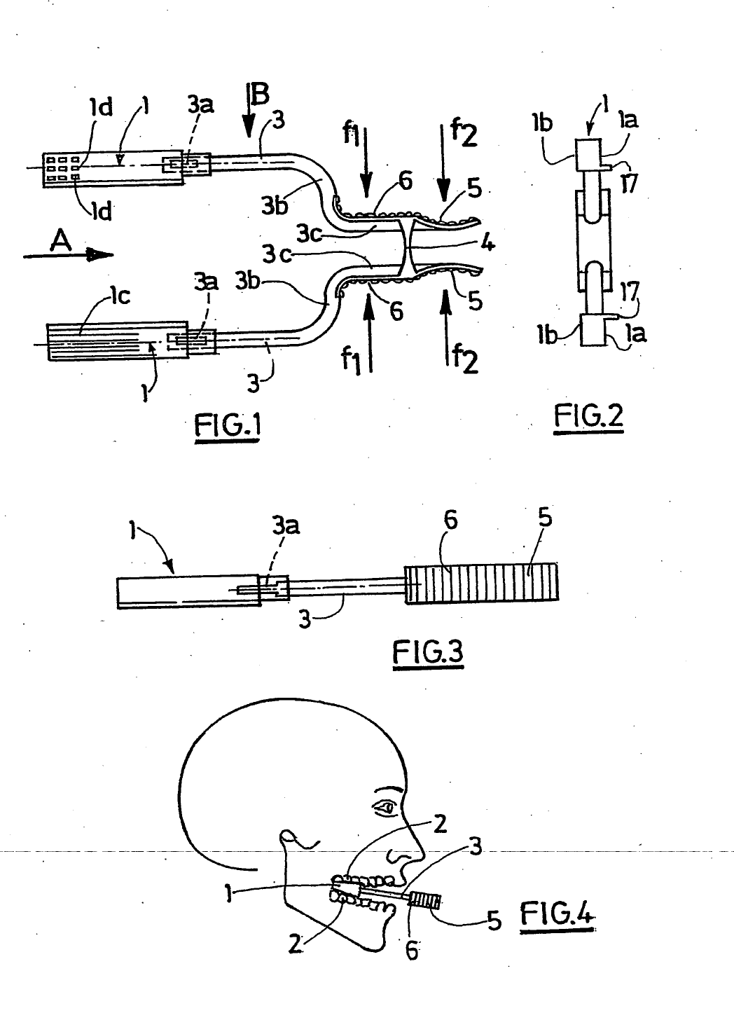

FIG. 2 is a view following the arrow A in FIG. 1,

FIG. 3 is a view following the arrow B in FIG. 1,

FIG. 4 is a view of the device in position in the mouth of a user,

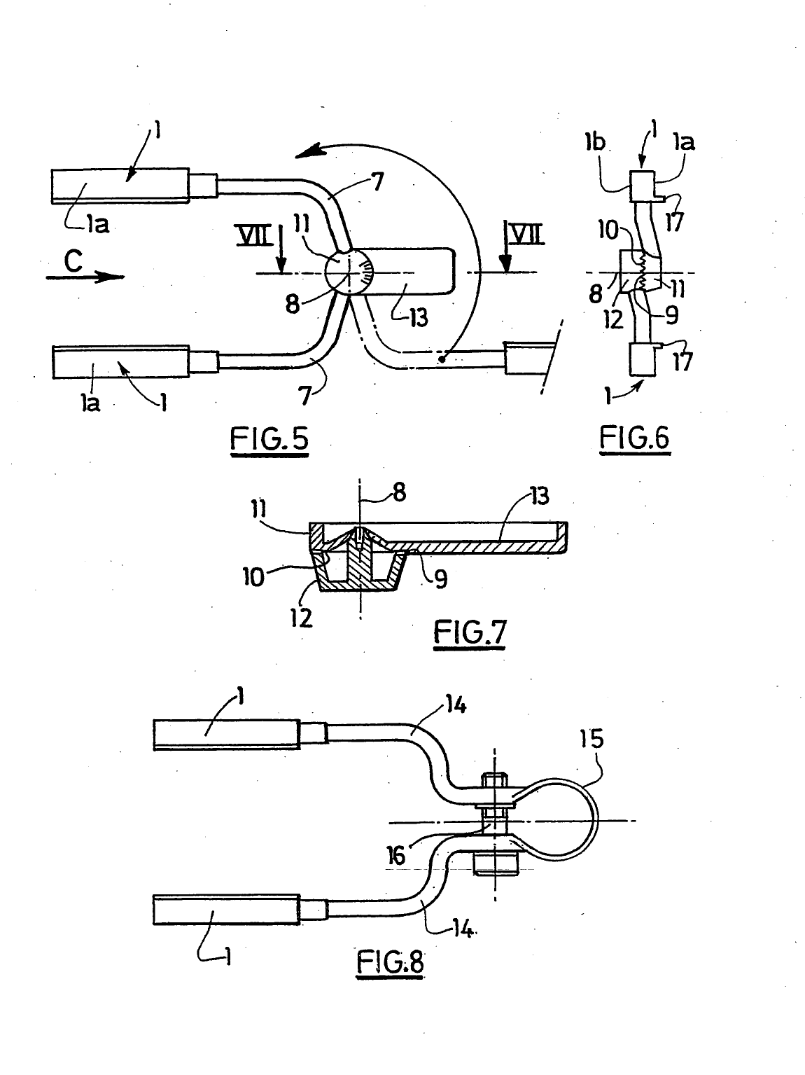

FIG. 5 is a top view of a second version of the device according to the invention,

FIG. 6 is a view following the arrow C in FIG. 5,

FIG. 7 is a cross-section following the plane VII-VII in FIG. 6,

FIG. 8 is a top view of a third version of the device according to the invention.

In the version shown in FIGS. 1, 2, and 3 the auto-adaptable intraoral device for self-correction of the asymmetry of the temporomandibular joints comprises two pads 1 of flexible material each intended, as shown by FIG. 4, to be clamped between the upper and lower molars 2.

These two pads 1 are connected to each other by a tie in particular to prevent them from being swallowed.

According to the invention, the tie. is constituted by two rods 3 of rigid material, the ends of which are each fixed to a pad 1. The ends of the rods 3 opposite the pads 1 are connected to each other by a flexible part 4 forming a hinge making it possible to adjust the distance between the two pads 1.

The two pads 1 are of flexible plastic and are moulded onto the ends 3a of the rods 3.

FIG. 1 shows that the two rods 3 are parallel to each other over most of their length, when they are not acted on manually.

Moreover, the two rods 3 comprise, opposite the pads 1, two bends 3b directed towards each other, which are extended by two rod sections 3c connected to each other by the flexible part 4 forming a hinge.

The flexible part 4 is constituted by a narrowing of the link between the two rods 3.

FIG. 1 also shows that the rod sections 3c extend beyond the flexible part 4 forming a hinge in order to constitute on both sides of the latter support surfaces 5, 6 for the thumb and the index figure making it possible to adjust the distance between the two pads 1 perpendicular to the molars before they are clamped by the latter.

By exerting (see FIG. 1) a force f1 on the surfaces 6, the pads 1 are moved closer together, whereas by exerting a force f2 on the surfaces 5, the pads are moved apart.

In the example shown, the support surfaces 5, 6 are formed of plastic moulded onto the rod sections which extend on both sides of the hinge 4.

The support surfaces 5, 6 advantageously comprise unevennesses for improving grip.

In the version shown in FIGS. 5, 6 and 7, the ends of the rods 7 opposite the two pads 1 are connected to each other by a hinge pin 8 perpendicular to the plane of the two rods 7. Each rod end 7 comprises a support surface 9 (see FIG. 6) in contact with the support surface 10 of the other rod end 7, the two support surfaces 9, 10 comprising friction means constituted by notches formed on moulded plastic blocks 11, 12.

FIG. 7 shows that one 10 of the support surfaces is extended in a direction opposite the pads 1 by a gripping lug 13.

In the version shown in FIG. 8, the ends of the rods 14 opposite the two pads 1 are connected to each other by a substantially circular flexible narrowed part 15 and by an adjusting screw 16 making it possible to adjust the distance between the two rods 14 and the two pads.

Moreover, in all the devices represented, each pad 1 comprises (see in particular FIGS. 2 and 6) two plane opposite support faces 1a, 1b intended to come into contact with the molars, comprising (see FIG. 1) ribs 1c, humps 1d or other unevennesses.

These arrangements allow a better seating of the molars on the pads 1.

Moreover (see in particular FIGS. 2 and 6) the pads 1 comprise on their internal side face a fin 17 suitable for guiding these pads laterally with respect to the molars.

Thus, the examples of the device according to the invention offer numerous advantages compared with that described in the prior art.

In particular, it is much easier to use and to place between the molars, thanks in particular to the arrangements which have been described which make it possible to adjust the distance between the pads.

Of course, the invention is not limited to the examples which have just been described and numerous modifications can be made to the latter without the scope of the invention being exceeded.

1-13. (canceled)

14. Auto-adaptable intraoral device for self-correction of the asymmetry of the temporomandibular joints, comprising two pads (1) of flexible material each intended to be clamped between the upper and lower molars, these two pads (1) being connected to each other by a tie in order to prevent them from being swallowed, characterized in that said tie is constituted by two rods (3, 7, 14) of rigid material the ends of which are each fixed to a pad, the ends of the rods opposite the pads (1) being connected to each other by a part (4, 8, 15) forming a hinge making it possible to adjust the distance between the two pads (1) with one hand only by the pressure of thumb and index finger alone.

15. Device according to claim 14, characterized in that the two pads (1) are of flexible plastic and are moulded onto the ends (3a) of said rods (3, 7, 14).

16. Device according to claim 14, characterized in that the two pads (1) are substantially parallel to each other, and when they are not acted on manually, the distance between them corresponds to that between the molars of a jaw of average size.

17. Device according to claim 16, characterized in that the two rods (3) comprise opposite the pads (1), two bends (3b) directed one towards the other which are extended by two rod sections (3c) connected to each other by a flexible part (4) forming a hinge.

18. Device according to claim 17, characterized in that said flexible part (4) is constituted by a narrowing of the link between the rod sections (3c).

19. Device according to one of claim 17, characterized in that said rod sections (3c) extend beyond the flexible part (4) forming a hinge, to constitute on both sides of the latter support surfaces (5, 6) for the thumb and index finger allowing adjustment of the distance between the two pads (1) perpendicular to the molars before they are clamped by the latter.

20. Device according to claim 19, characterized in that said support surfaces (5, 6) are formed of plastic moulded onto said rod sections (3c).

21. Device according to one of claim 14, characterized in that the ends of the rods (7) opposite the two pads (1) are connected to each other by a hinge pin (8) perpendicular to the plane of the two rods (7), each rod end comprising a support surface (9) in contact with the support surface (10) of the other rod end, the two support surfaces (9, 10) comprising friction means.

22. Device according to claim 21, characterized in that the friction means are notches.

23. Device according to one of claim 21, characterized in that one (9) of the support surfaces is extended in a direction opposite the pads (1) by a gripping lug (13).

24. Device according to one of claim 14, characterized in that the ends of the rods (14) opposite the two pads (1) are connected to each other by a substantially circular flexible narrowed part (15) and by an adjusting screw (16) making it possible to adjust the distance between the two rods (14).

25. Device according to one of claim 14, characterized in that each pad (1) comprises two opposite support faces (1a, 1b) intended to come into contact with the molars, comprising ribs (1c), humps (1d) or other unevennesses.

26. Device according to one of claim 14, characterized in that the pads (1) comprise on their internal side face a fin (17) suitable for guiding these pads laterally with respect to the molars.
